(19) United States
(12) Patent Application Publication
(10) Pub. No.: US 2009/0146928 A1
(43) Pub. Date: Jun. 11, 2009

(54) Organic Electroluminescence Display Device

(76) Inventors: Mitsuhide Miyamoto, Kawasaki (JP); Tohru Kohno, Kokubunji (JP); Hajime Akimoto, Kokubunji (JP); Hiroshi Kageyama, Hachioji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/331,536

(22) Filed: Dec. 10, 2008

(30) Foreign Application Priority Data
Dec. 10, 2007 (JP) 2007-318273

(51) Int. Cl. G09G 3/30

(52) U.S. Cl. 345/76

(57) ABSTRACT

Before a reset operation in which a threshold voltage Vth of an organic light emitting diode (OLED) driving thin film transistor (TFT) is compensated is performed by a first reset TFT switch, a second reset TFT switch is turned on to apply a reset reference potential to a gate of the OLED driving TFT. Accordingly, an operation point of the OLED driving TFT can be stably set even when a power supply is low. In the reset operation, it is unnecessary to close a lighting TFT switch and cause an OLED element to emit light, whereby constant can be improved.

### CLAIM OF PRIORITY

The present application claims priority from Japanese application JP 2007-318273 filed on Dec. 10, 2007, the content of which is hereby incorporated by reference into this application.

### BACKGROUND OF THE INVENTION

1. Field of the Invention

The present invention relates to an organic electroluminescence (EL) display device, and more particularly, to an organic EL display device having less pixel-to-pixel fluctuation in gradation display and having excellent contrast.

2. Description of the Related Art

Compared to a liquid crystal display device, an organic EL display device has the following features: aback light is unnecessary because the organic EL display device is a self-emission type, the organic EL display device is excellent in moving picture characteristics because of its short response time of several microseconds, there is a potentiality to reduce consumption power because voltage required for light emission is 10 V or lower, and the like. Further, compared to a plasma display device and a field emission display (FED) device, the organic EL display device has the following feature: the organic EL display device may suitably be lightened and thinned because a vacuum structure is unnecessary, and the like.

An organic EL display device using a thin film transistor (TFT) as a switching element is excellent in image qualities in terms of contrast, etc. However, when the gradation display is performed, display characteristics vary due to an influence of the characteristic fluctuation of each TFT. As an example of a related art considered as a countermeasure against the fluctuation of the display characteristics, there is given a technology as described in JP 2003-122301 A. FIGS. 11 and 12 each illustrate the technology described in JP 2003-122301 A.

FIG. 11 illustrates a drive circuit of a pixel portion described in JP 2003-122301 A. In FIG. 11, an organic light emitting diode (OLED) driving TFT 3, a lighting TFT switch 2, and an organic EL light emitting element (OLED element) 1 are connected to each other in series from a power supply line 51, and one terminal of the OLED element 1 is connected to a reference potential. Here, the reference potential is a potential to be a reference for the display device, and is a wide-ranging concept including an earth potential. Current flowing in the OLED element 1 is controlled, whereby light emission of the OLED element 1 is controlled and an image is formed. The lighting TFT switch 2 controls whether or not current is allowed to flow in the OLED element 1.

The gradation of light emission intensity from the OLED element 1 is controlled by the OLED driving TFT 3 based on a signal sent from a data line 50. In other words, the signal sent from the data line 50 is stored in a capacitive element 4 connected to a gate of the OLED driving TFT 3, and current flowing in the OLED driving TFT 3 based on a potential of the capacitive element 4 is controlled, whereby the gradation display may be performed. However, in the OLED driving TFT 3, fluctuation of a threshold voltage Vth is large due to manufacture fluctuation. In order to compensate the fluctuation of the threshold voltage Vth, current is allowed to flow in the OLED driving TFT 3 for a short period of time, and a reset TFT switch 5 is tuned on at the same time. Then, a gate voltage V10 of the OLED driving TFT 3 is set to a value obtained by taking the threshold voltage Vth of the OLED driving TFT 3 into consideration, and the OLED element 1 emits light faithfully according to an image signal.

FIG. 12 is a timing chart for driving the drive circuit of FIG. 11. As illustrated in the upper portion of FIG. 12, the drive circuit divides one frame into the first half thereof, that is, a write operation period, and the latter half thereof, that is, a light emission period. A gradation signal is written in each pixel during the write operation period. A write operation position of FIG. 12 indicates how data is written in an order of scanning lines. The lower portion of FIG. 12 illustrates a write timing of one pixel. In FIG. 12, the reset TFT switch 5 is first turned on to forcedly short-circuit the gate voltage V10 and a drain voltage V12. Thereafter, the lighting TFT switch 2 is turned on to allow current to flow in the OLED driving TFT 3. The time period during which the lighting TFT switch 2 and the reset TFT switch 5 are turned on at the same time is denoted by tc as illustrated in FIG. 12. When the tc is sufficiently long, the gate voltage V10 of the OLED driving TFT 3 converges on a value of an intersection between a characteristic curve of the gate voltage V10 and the drain voltage V12 of the OLED driving TFT 3, and a straight line of V10=V12.

There is given JP 2003-5709 A, in which another technology as countermeasure against the fluctuation of the threshold voltage Vth of the OLED driving TFT 3 is described.

In the related arts described above, an operation point of the driving transistor is set to the intersection between a voltage-current characteristic of the driving transistor and a voltage-current characteristic of an OLED element characteristic. However, in a case where a supply voltage is reduced so as to reduce the power consumption, the operation point becomes unstable as described later. In addition, in order to set the operation point, though it is a short period of time, current is required to flow in the OLED element, during which the OLED element emits light. This light emission is irrelevant to an image formation, and hence the contrast is reduced. Hereinafter, this problem is described.

FIG. 13 is a pixel circuit according to the related art illustrated in FIG. 11. For the simplification of the description, in FIG. 13, the switches formed of the TFTs are denoted by a switch symbol, instead of a symbol of a field effect transistor. Note that, in fact, those switches are formed of TFT switches, and hence are called TFT switches.

With reference to FIG. 13, in a pixel 10, the OLED driving TFT 3, the lighting TFT switch 2, and the OLED element 1 are connected to each other in series. The reset TFT switch 5 is arranged between a drain and a gate of the OLED driving TFT 3. To the gate of the OLED driving TFT 3, the capacitive element 4 having one terminal connected to the data line 50 is connected. The reset TFT switch 5 is controlled by a reset control line RES, and the lighting TFT switch 2 is controlled by a lighting control line ILM.

FIG. 14 is a timing chart of the write operation, which corresponds to FIG. 12 of the related art. The related art reset TFT switch illustrated in FIG. 12 is turned on in response to the supply of video data. On the other hand, FIG. 14 illustrates that the reset control line RES for controlling the operation of the reset TFT switch is turned on after the supply of video data, thereby turning on the reset TFT switch. In both cases, the write operation can be performed.

In FIG. 14, the reset control line RES controls the operation of the reset TFT switch 5. When the reset control line RES is in ON state, the reset TFT switch 5 is in ON state. The lighting control line ILM controls the operation of the lighting TFT switch 2. When the lighting control line ILM is in ON state, the lighting TFT switch 2 is in ON state. Further, FIG. 14 illustrates that the ON state of a line RSEL indicates that a red pixel is selected, the ON state of a line GSEL indicates that a green pixel is selected, and the ON state of a line BSEL indicates that a blue pixel is selected. When one line is selected, video data is first supplied to the red pixel, the video data is next supplied to the green pixel, and the video data is then supplied to the blue pixel.

In this state, the data line 50 illustrated in FIG. 13, that is, the one terminal of the capacitive element 4 is set to a potential corresponding to the video data. After that, when the reset TFT switch 5 is turned on and the lighting TFT switch 2 is tuned on at the same time, current is allowed to flow in the OLED driving TFT 3, the lighting TFT switch 2, and the OLED element 1. Further, the current flows in the capacitive element 4 via the lighting TFT switch 2, whereby another terminal of the capacitive element 4 is set to a predetermined potential. This is called a reset operation. At the period of time during which the reset TFT switch 5 and the lighting TFT switch 2 are turned on at one time, the reset operation is conducted. In other words, this operation is to allow charges stored in the capacitive element 4 according to the video data of the prior frame to escape to the earth potential or reference potential by turning on the lighting TFT switch 2.

FIGS. 15A and 15B illustrate a pixel circuit in this state. FIG. 15A illustrates a state where the reset TFT switch 5 for connecting the gate and the drain of the OLED driving TFT 3 is in ON state and the lighting TFT switch 2 is also in ON state. In this state, the gate and the drain of the OLED driving TFT 3 are short-circuited by the reset TFT switch 5, whereby the OLED driving TFT 3 serves as a diode. Further, the lighting TFT switch 2 is in ON state, and hence is in a short-circuited state.

FIG. 15B illustrates an equivalent circuit of FIG. 15A. In FIG. 15B, two diodes are connected to each other in series. A point A illustrated in FIGS. 15A and 15B has a potential of the another terminal of the capacitive element 4, and charges according to a potential difference between the potential of the point A and the potential of the data line 50 are stored in the capacitive element 4. Accordingly, how to determine the potential of the point A is important.

FIG. 16 indicates how to determine the potential of the point A in a normal state. In FIG. 16, a characteristic curve of the OLED driving TFT 3 is denoted by TR, which indicates a relation between current and a source-drain voltage of the OLED driving TFT 3 forming a diode. Symbol OLED of FIG. 16 indicates a relation between current and an inter-terminal voltage of the OLED element 1 forming a diode. The point A of FIGS. 15A and 15B is set to an intersection between the characteristic curve TR and a curve OLED of FIG. 16.

Note that, in FIG. 16, Vth(oled) is voltage at which current starts to flow out in the OLED element 1 forming a diode, and Vth (tr) is voltage at which current starts to flow out in the OLED driving TFT 3 forming a diode. In addition, Voled is a positive voltage of the OLED element 1. As illustrated in FIG. 16, Voled-Vth(oled)−Vth(tr)=V(A), and the V(A) has a certain range. Accordingly, in the case where the characteristic of the OLED driving TFT 3 varies, the potential of the point A illustrated in FIG. 15A can be set stably.

However, in the case where the supply voltage, that is, the positive voltage Voled is reduced so as to reduce the power consumption of the organic EL display device, there arises a problem. This problem is described in FIG. 17. Compared to FIG. 16, FIG. 17 indicates a lower positive voltage Voled of the OLED element 1. On the other hand, when elements having the same characteristics are used for the OLED element 1 and the OLED driving TFT 3, Vth (oled) and Vth(tr) are equal to those of FIG. 16. As a result, there is a case where Voled-Vth(oled)−Vth(tr) becomes negative. In this case, as illustrated in FIG. 17, the intersection between the characteristic curve of the OLED driving TFT 3 and the characteristic curve of the OLED element 1 is not generated. Accordingly, there is generated a phenomenon in which the potential of the operation point A of FIG. 15A is not determined, which means that the gradation display cannot be performed accurately.

Another problem in a conventional pixel circuit resides in that, in the reset operation illustrated in FIG. 14, when current is allowed to flow in the lighting TFT switch 2 to allow the charges stored in the capacitive element 4 at the time of the prior frame to escape, the OLED element 1 emits light. In the operation of the conventional pixel circuit described above, a black display is performed in the write operation period, and each pixel emits light according to the video data in the light emission period to thereby form an image.

The light emitted from the OLED element 1 for reset in the write operation period is irrelevant to the image formation. Accordingly, the light emitted from the OLED element 1 in the write operation period reduces the contrast of the image.

### SUMMARY OF THE INVENTION

The present invention has been made to solve the above-mentioned problems, and an outline of the present invention is as follows. A second reference potential is set, and a switching means is arranged between the second reference potential and a gate of an organic light emitting diode (OLED) driving thin film transistor (TFT). The switching means is closed before a reset operation of the OLED driving TFT, and the second reference potential is supplied to the gate of the OLED driving TFT, whereby a gate potential of the OLED driving TFT is certainly set.

Further, with this structure, it is not required to make current to flow in an OLED element at a time of the reset operation. Accordingly, a complete black display is performed in a write operation period, and contrast of an image is increased. A specific means is as follows.

An organic electroluminescence display device according to a first aspect of the present invention includes: a display portion formed of a plurality of pixels each including a self-light-emitting element; a data line for inputting an image data signal into the display portion; and a field effect transistor for driving the self-light-emitting element based on image data input into each of the plurality of pixels via the data line. The field effect transistor is connected to a first switch and an organic light emitting diode element in series between a power supply and a first reference potential, and has a drain and a gate connected to a second switch provided therebetween. The gate of the field effect transistor is connected to a second reference potential with a third switch being connected therebetween. The gate of the field effect transistor is connected to one terminal of a capacitive element, and the data line is connected to another terminal of the capacitive element.

Further, according to the first aspect of the present invention, each of the field effect transistor, the first switch, the second switch, and the third switch may be formed of a thin film transistor.

Further, according to the first aspect of the present invention, the field effect transistor may be p-type and may be connected to the power supply, and the organic light emitting diode element may be connected to the first reference potential.

Further, according to the first aspect of the present invention, the field effect transistor may be n-type and may be connected to the first reference potential, and the organic light emitting diode element may be connected to the power supply.

Further, according to the first aspect of the present invention, the first reference potential and the second reference potential may be equal to each other.

Further, an organic electroluminescence display device according to a second aspect of the present invention includes: a display portion formed of a plurality of pixels including a first pixel and a second pixel each including a self-light-emitting element; a data line for inputting an image data signal into the display portion; and a field effect transistor for driving the self-light-emitting element based on image data input into each of the plurality of pixels via the data line. The first pixel is configured so that: the field effect transistor is connected to a first switch and an organic light emitting diode element in series between a power supply and a first reference potential; the field effect transistor has a drain and a gate connected to a second switch provided therebetween; the gate of the field effect transistor is connected to a third switch which is controlled by a control line; and the gate of the field effect transistor is connected to one terminal of a capacitive element, and the data line is connected to another terminal of the capacitive element. The second pixel has the same structure as in the first pixel. The third switch of the first pixel is connected to a control line of the second pixel, and a third switch of the second pixel is connected to the control line of the first pixel.

Further, according to the second aspect of the present invention, each of the field effect transistor, the first switch, the second switch, and the third switch may be formed of a thin film transistor.

Further, according to the second aspect of the present invention, the field effect transistor may be p-type and may be connected to the power supply, and the organic light emitting diode element may be connected to the first reference potential.

Further, according to the second aspect of the present invention, the field effect transistor may be n-type and may be connected to the first reference potential, and the organic light emitting diode element may be connected to the power supply.

Further, there is provided a driving method for an organic electroluminescence display device according to a third aspect of the present invention, the organic electroluminescence display device including: a display portion formed of a plurality of pixels each including a self-light-emitting element; a data line for inputting an image data signal into the display portion; and a field effect transistor for driving the self-light-emitting element based on image data input into each of the plurality of pixels via the data line. The field effect transistor is connected to a first switch and an organic light emitting diode element in series between a power supply and a first reference potential, the field effect transistor has a drain and a gate connected to a second switch provided therebetween, the gate of the field effect transistor is connected to a second reference potential with a third switch being connected therebetween, the gate of the field effect transistor is connected to one terminal of a capacitive element, and the data line is connected to another terminal of the capacitive element. One frame period is divided into a data write period in which data is written in the plurality of pixels and a light emission period of the plurality of pixels. In the data write period, the third switch is closed when data is being input from the data line into the capacitive element, the second reference potential is applied to the gate of the field effect transistor, and the third switch is open when the second switch is closed.

Further, according to the third aspect of the present invention, in the data write period, the first switch may be open and the organic light emitting diode element may not emit light.

Further, according to the third aspect of the present invention, the first reference potential and the second reference potential may be equal to each other.

Further, there is provided a driving method for an organic electroluminescence display device according to a fourth aspect of the present invention, the organic electroluminescence display device including: a display portion formed of a plurality of pixels including a first pixel and a second pixel each including a self-light-emitting element; a data line for inputting an image data signal into the display portion; and a field effect transistor for driving the self-light-emitting element based on image data input into each of the plurality of pixels via the data line. The first pixel is configured so that: the field effect transistor is connected to a first switch and an organic light emitting diode element in series between a power supply and a first reference potential; the field effect transistor has a drain and a gate connected to a second switch provided therebetween; the gate of the field effect transistor is connected to a third switch which is controlled by a control line; and the gate of the field effect transistor is connected to one terminal of a capacitive element, and the data line is connected to another terminal of the capacitive element. The second pixel has the same structure as in the first pixel. The third switch of the first pixel is connected to a control line of the second pixel and a third switch of the second pixel is connected to the control line of the first pixel. One frame period is divided into a data write period in which data is written in the plurality of pixels and a light emission period of the plurality of pixels. In the data write period, the first pixel is configured so that the third switch is closed when data is being input from the data line into the capacitive element, an OFF potential of the control line of the second pixel is supplied to the gate of the field effect transistor, and the third switch is open when the second switch is closed. The second pixel is configured so that the third switch is closed when data is being input from the data line into the capacitive element, an OFF potential of the control line of the first pixel is supplied to the gate of the field effect transistor, and the third switch is open when the second switch is closed.

Further, according to the fourth aspect of the present invention, in the data write period, the first switch of the first pixel and the first switch of the second pixel may be open, and the organic light emitting diode element of the first pixel and the organic light emitting diode element of the second pixel may not emit light.

With the use of the present invention, even when a driving supply voltage of the organic electroluminescence (EL) display device is reduced, the fluctuation of Vth of the organic light emitting diode (OLED) driving thin film transistor (TFT) can be compensated, and at the same time, an operation point of the OLED driving TFT can be stabilized. When the driving supply voltage of the organic EL display device can be reduced, consumption power thereof can be reduced.

Further, according to the present invention, at the time of the reset operation in which the fluctuation of Vth of the OLED driving TFT is compensated, the OLED element is not required to be lighted, whereby contrast of an image can be improved.

### BRIEF DESCRIPTION OF THE DRAWINGS

In the accompanying drawings:

FIG. 1 is an appearance diagram of an organic electroluminescence (EL) display device according to an embodiment of the present invention;

FIG. 2 is a diagram for describing an operation during one frame period in the embodiment of the present invention;

FIG. 3 is a structural diagram of a selector according to the embodiment of the present invention;

FIG. 4 is a circuit diagram illustrating a pixel circuit according to a first embodiment of the present invention;

FIG. 5 is a timing chart showing an operation of the pixel circuit illustrated in FIG. 4;

FIG. 6A is a schematic diagram illustrating a reset operation of the pixel circuit illustrated in FIG. 4;

FIG. 6B is another schematic diagram illustrating the reset operation of the pixel circuit illustrated in FIG. 4;

FIG. 6C is still another schematic diagram illustrating the reset operation of the pixel circuit illustrated in FIG. 4;

FIG. 7 is a diagram illustrating a characteristic of an organic light emitting diode (OLED) driving thin film transistor (TFT) in the reset operation;

FIG. 8 is a diagram illustrating a wave form of a light emission period in one frame;

FIG. 9 is a circuit diagram illustrating a pixel circuit according to a second embodiment of the present invention;

FIG. 10 is a circuit diagram illustrating a pixel circuit according to a third embodiment of the present invention;

FIG. 11 is a diagram illustrating an example of a conventional pixel circuit;

FIG. 12 is a timing chart for driving the pixel circuit of FIG. 11;

FIG. 13 is a diagram illustrating an example of a conventional pixel circuit;

FIG. 14 is a timing chart showing an operation of the pixel circuit of FIG. 13;

FIG. 15A is a schematic diagram illustrating a state of a reset operation;

FIG. 15B is another schematic diagram illustrating the state of the reset operation;

FIG. 16 is an example in which an operation point is set in the example of the conventional pixel circuit; and

FIG. 17 is an example in which the operation point becomes unstable in the example of the conventional pixel circuit.

### DETAILED DESCRIPTION OF THE INVENTION

The present invention is disclosed in detail according to embodiments thereof.

### First Embodiment

FIG. 1 is an appearance schematic diagram of an organic electroluminescence (EL) display device 100 according to the embodiments of the present invention. In FIG. 1, a driver IC 150 and a flexible wiring board 160 are arranged in an organic EL display panel 110. The organic EL display panel 110 includes a display portion 120 in which a number of pixels each including a pixel circuit and an organic EL light emitting layer are formed in matrix. On a left side of the display portion 120, a scanning circuit 130 is formed. The scanning circuit 130 is formed of TFTs, similarly to the pixel circuit of the display portion 120.

On a lower side of the organic EL display device 100, a selector 140 is formed. The selector 140 has a function of selecting write operation or light emission operation in one frame and a function of dividing video data of the write operation supplied from the driver IC 150 into red pixels, green pixels, and blue pixels. The flexible wiring board 160 is mounted to a lower side of the organic EL display panel 110, and video data, power supply, and the like are supplied from the flexible wiring board 160.

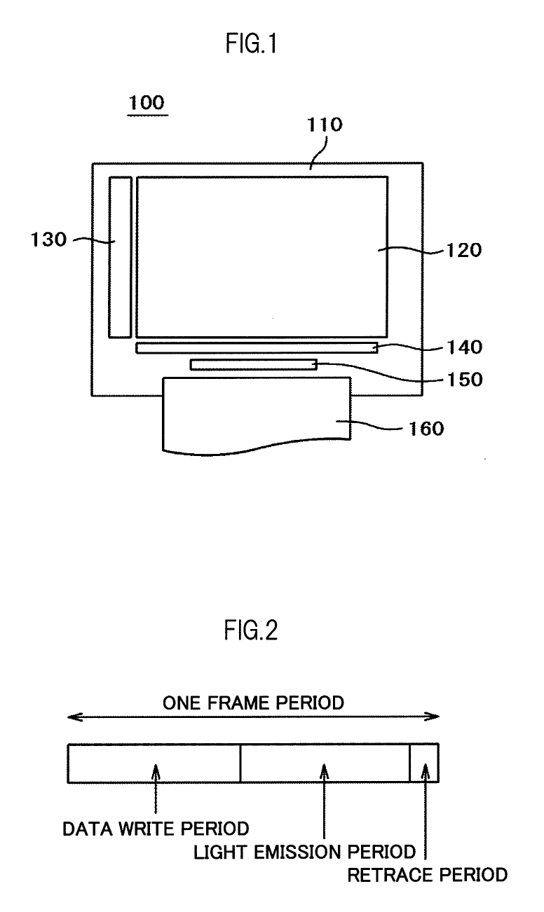

FIG. 2 illustrates a driving method for the organic EL display device 100 in this embodiment. A unit of images is formed by a frame, and in this embodiment, one frame is divided into a data write period, a light emission period, and a retrace period. In the retrace period, detection of characteristic changes of an organic EL light emitting diode (OLED) element 1 and the like are conducted. However, the retrace period is short, and hence it may be assumed that the first half of the one frame is the data write period and the latter half thereof is the light emission period.

During the data write period of the first half, the OLED element 1 does not emit light, and a black display is performed. However, conventionally, even in the data write period, the OLED element 1 has been caused to emit light for a short period of time because of a reset operation for each pixel. This light emission is irrelevant to an image, and hence the contrast is reduced. This embodiment copes with this problem as described below.

After the write operation is finished in the first half of the one frame, all the pixels are caused to emit light according to the video data stored in each pixel in the latter half of the one frame, whereby an image is formed. In this way, according to this system, a display period of image and a black display are alternately formed. The organic EL display device has a so-called hold type display system. The hold type display is different from an impulse type display such as a cathode ray tube (CRT) in that the hold type display has difficulty in moving picture characteristics. However, in the display system as illustrated in FIG. 2, the black display is included between images, whereby there is produced an advantage in that the moving picture characteristics are greatly improved.

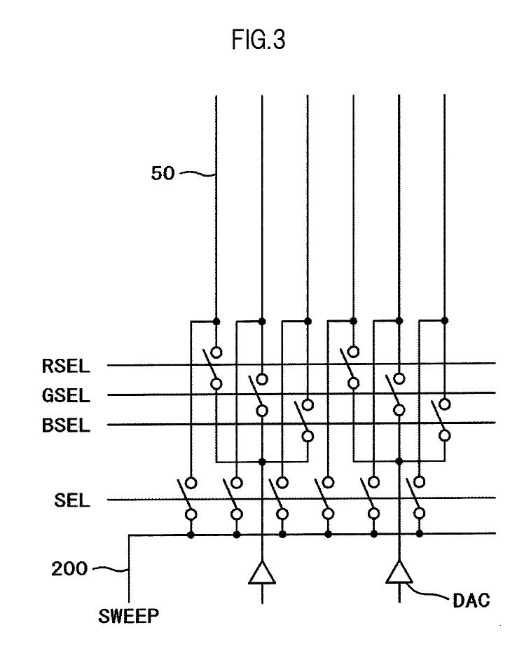

FIG. 3 is a detail diagram of the selector 140 illustrated in FIG. 1. In this embodiment, as described above, one frame is divided into two to write video data in each pixel in the first half of the frame. A select line SEL illustrated in FIG. 3 separates the write operation in the first half of the frame from the light emission operation in the latter half thereof. In other words, in the data write period in the first half of the frame, a select switch SEL is turned off.

In the latter half of the frame in which the write operation has been completed, the select switch SEL is turned on, and a sweep signal SWEEP is applied from a triangle wave input line 200. The sweep signal is a triangle wave. When an OLED driving TFT 3 is a p-type TFT, the triangle wave has a waveform having a convex shape downwardly. On the other hand, when the OLED driving TFT 3 is an n-type TFT, the triangle wave has a waveform having a convex shape upwardly. The triangle wave is added to each pixel, and hence a period in which each pixel emits light corresponds to charges stored in a capacitive element 4 of each of the pixels, whereby an image reflecting the gradation is formed.

Next, the write operation in each pixel is described. In FIG. 3, in a period during which the write is performed in each pixel, the select switch SEL is turned off. In FIG. 3, data lines 50 extend in a vertical direction, and are arranged in a lateral direction. The number of the data lines 50 is the same as the number of sub-pixels arranged in the lateral direction. Video data is supplied via a digital-analog converter DAC illustrated in FIG. 3. Video signals of red, green, and blue are not supplied at once. Video signals are supplied to the data lines 50 as red data, green data, and blue data with time intervals. The supply of the data signals with the time intervals is controlled by a red select line RSEL, a green select line GSEL, and a blue select line BSEL. Specifically, when the video data with respect to red pixels is being supplied, a red select switch is in ON state, but a green select switch and a blue select switch are in OFF state. The supply of video data to green pixels and blue pixels are performed in the same way.

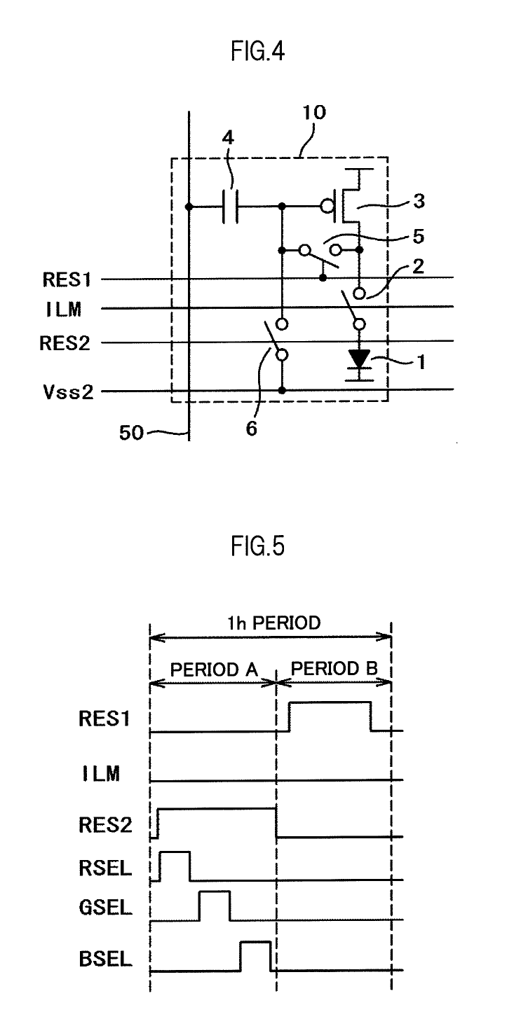

FIG. 4 illustrates the pixel circuit according to this embodiment. In FIG. 4, a switch symbol is used and all switches are formed of TFTs. Accordingly, hereinafter, those switches are referred to as TFT switches. Further, the OLED driving TFT 3 and other TFT switches are field effect transistors. With reference to FIG. 4, in a pixel 10, the OLED driving TFT 3, a lighting TFT switch 2, and the OLED element 1 are connected to each other in series. A first reset TFT switch 5 is connected between a drain and a gate of the OLED driving TFT 3. The capacitive element 4 is present between the data line 50 and the gate of the OLED driving TFT 3. In the capacitive element 4, charges corresponding to video data are stored. A first reset control line RES1 controls the first reset TFT switch 5, and a second reset control line RES2 controls a second reset TFT switch 6. Further, a lighting control line ILM controls the lighting TFT switch 2.

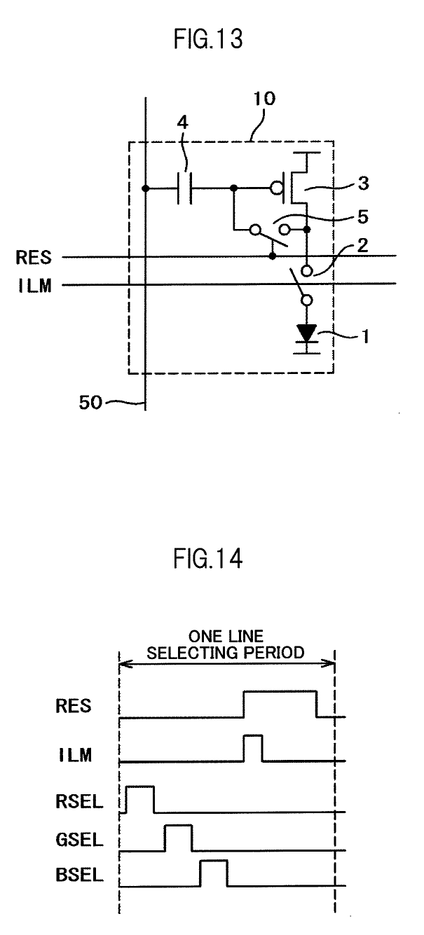

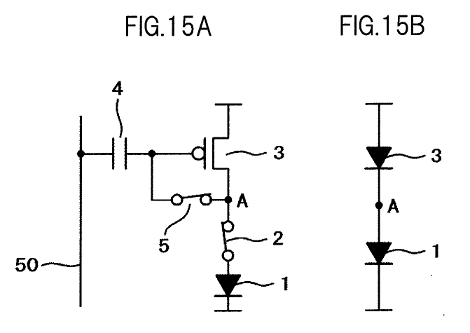

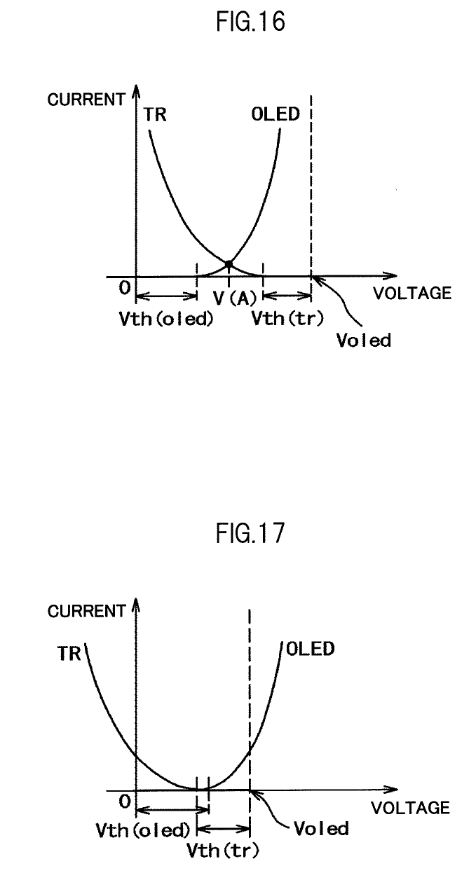

The feature of the circuit of FIG. 4 resides in that the second reset TFT switch 6 is provided and connected between the gate of the OLED driving TFT 3 and a reset reference potential Vss2, unlike the conventional pixel circuit illustrated in FIG. 13. In a reset operation, the reset reference potential Vss2 is supplied to the gate of the OLED driving TFT 3 via the second reset TFT switch 6. The first reset TFT switch 5 is controlled by the first reset control line RES1, and the second reset TFT switch 6 is controlled by the second reset control line RES2.

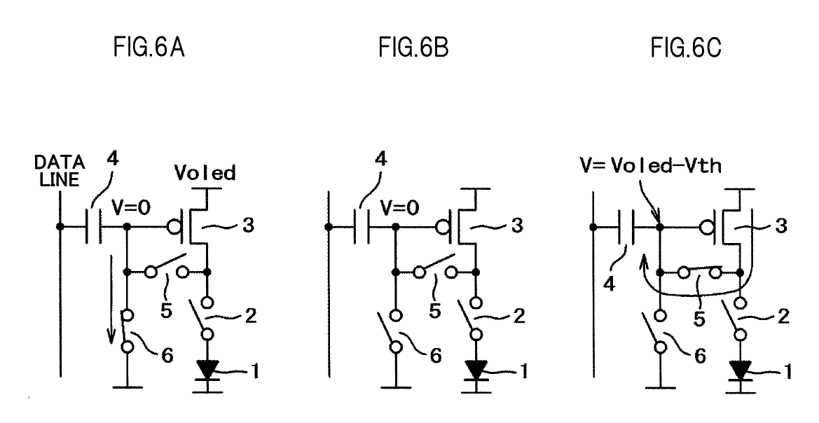

FIGS. 5 and 6A to 6C are diagrams illustrating an operation of the pixel circuit illustrated in FIG. 4. FIG. 5 is a timing chart showing a write operation in one line. In FIG. 5, a first half period A is for inputting a video signal. In the period A of FIG. 5, as illustrated in FIG. 3, a pulse on the red select line RSEL indicates that the red select switch is turned on to input a red data signal and a pulse on the green select line GSEL indicates that the green select switch is turned on to input a green data signal. The same applies to a pulse on the blue select line BSEL.

In the period A during which the red data, the green data, and the blue data are being input, the second reset control line RES2 turns on the second reset TFT switch 6. At the same time, the first reset control line RES1 turns off the first reset TFT switch 5. Further, the lighting control line ILM turns off the lighting TFT switch 2. Accordingly, the reset reference potential Vss2 is applied to the gate of the OLED driving TFT 3. This state is illustrated in FIG. 6A. As illustrated in FIG. 6A, in the period A, charges corresponding to video data are stored in the capacitive element 4.

After that, the second reset TFT switch 6 is turned off to close the period A. In this state, the charges stored in the capacitive element 4 based on the video data are retained. This state is illustrated in FIG. 6B. As illustrated in FIG. 6B, in this state, the first reset TFT switch 5, the second reset TFT switch 6, and the lighting TFT switch 2 are all turned off. This state continues for a short period of time until the first reset TFT switch 5 is turned on in a period B of FIG. 5.

Next, in the period B of FIG. 5, the first reset TFT switch 5 is turned on. Then, the OLED driving TFT 3 serves as a diode, and hence current flows from a power supply Voled to the gate of the OLED driving TFT 3 having the reset reference potential Vss2. The current flows until a gate potential of the OLED driving TFT 3 becomes Voled-Vth. Here, Voled is a supply voltage and Vth is a threshold voltage of the OLED driving TFT 3. After the current has flowed, the gate potential of the OLED driving TFT 3 or a potential of a terminal of the capacitive element 4 connected thereto is set to a value corresponding to Voled-Vth. This state is illustrated in FIG. 6C.

Through the operation described above, the charges stored in the capacitive element 4 reflect the video data and the threshold voltage of the OLED driving TFT 3. Accordingly, the fluctuation of the threshold voltage of the OLED driving TFT 3 is compensated, which enables an accurate gradation display.

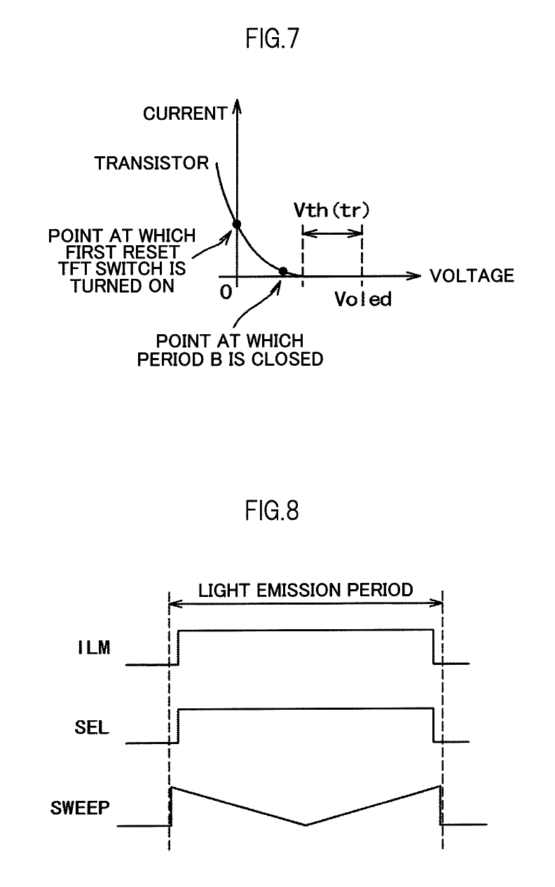

FIG. 7 illustrates a characteristic of the OLED driving TFT 3 in the reset operation described above. In FIG. 7, the ordinate indicates a drain current of the OLED driving TFT 3, and the abscissa illustrates the gate potential of the OLED driving TFT 3. Here, a zero-value point of the abscissa of FIG. 7 indicates that the gate potential of the OLED driving TFT 3 is set to the reset reference potential Vss2.

In FIG. 7, when the period A of FIG. 5 is closed and the first reset TFT switch 5 is turned on in the period B, current starts to flow in the OLED driving TFT 3. As the current flows to gradually charge the capacitive element 4, the gate potential of the OLED driving TFT 3 is increased, and the drain current of the OLED driving TFT 3 is decreased. Then, when the gate potential of the OLED driving TFT 3 is set to a value corresponding to Voled-Vth (tr), the drain current of the OLED driving TFT 3 is set to a value of zero. At this time point, the period B of FIG. 5 is also closed.

In FIG. 7, the supply voltage is Voled. As is apparent from FIG. 7, a condition that the pixel circuit is stably operated is that the Vth (tr) of the OLED driving TFT 3 is smaller than the supply voltage Voled. In this condition, compared to Voled-Vth(tr)−Vth(oled)>0, which is the operation condition of the conventional example, there is left voltage by Vth(oled) of the OLED element 1. Therefore, in this embodiment, the stability of the operation is greatly improved compared to conventional examples.

In the reset operation described above, the lighting TFT switch 2 is always in OFF state. Specifically, in the reset operation, the OLED element 1 does not emit light. More specifically, in the write operation, a complete black display is performed, which improve the contrast, compared to conventional examples.

As described above, the video data is written in the whole pixels in a display region in the first half of the one frame, and after that, the light emission operation is performed in the latter half of the one frame. Specifically, as illustrated in FIG. 8, in the latter half of the one frame, the red select switch RSEL, the green select switch GSEL, and the blue select switch BSEL of FIG. 3 are turned off, and the select switch SEL is turned on. At the same time, a triangle wave denoted by SWEEP of FIG. 8 is input from the triangle wave input line 200 of FIG. 3. In this embodiment, the OLED driving TFT 3 is a p-type TFT, whereby the triangle wave takes a waveform having a convex shape downwardly. This triangle wave can make the OLED driving TFT 3 to be lighted according to the charges stored in each pixel and can form an image according to the video image.

The above-mentioned description has been made on the assumption that the OLED driving TFT 3 is the p-type TFT. However, even in the case of an n-type OLED driving TFT 3, the pixel circuit according to this embodiment can be structured. In FIG. 4 in which the p-type OLED driving TFT 3 is used, the OLED driving TFT 3 is connected to a power supply side, the OLED element 1 is connected to a reference potential side, and the lighting TFT switch 2 is connected between the OLED driving TFT 3 and the OLED element 1. However, in the case where the OLED driving TFT 3 is the n-type TFT, it is preferable to connect the OLED element 1 to the power supply side, the OLED driving TFT 3 to the reference potential side, and the lighting TFT switch 2 between the OLED element 1 and the OLED driving TFT 3. In this case as well, as a matter of course, the first reset TFT switch 5 is connected between the gate and the drain of the OLED driving TFT 3.

### Second Embodiment

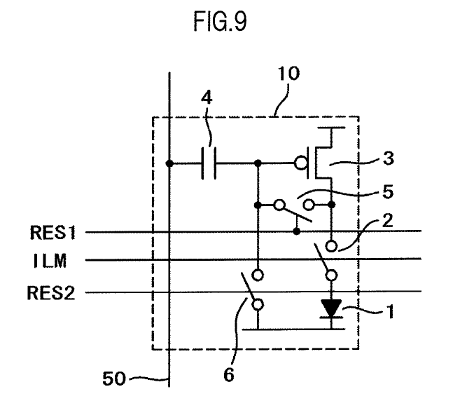

FIG. 9 is a diagram illustrating a pixel circuit according to a second embodiment of the present invention. In the first embodiment of the present invention, the reset reference potential Vss2 is separately prepared to thereby supply the reset reference potential Vss2 to the gate of the OLED driving TFT 3 via the second reset TFT switch 6. Therefore, wiring for supplying the reset reference potential Vss2 and wiring for supplying a reset reference potential are required, which raises the manufacturing cost for an organic EL display device.

In this embodiment, a reset reference potential is not separately prepared, and the reset reference potential is shared with a reference potential of an OLED element 1. With this structure, the above-mentioned problem is solved. In FIG. 9, one terminal of a second reset TFT switch 6 is connected to the reference potential of the OLED element 1. Further, another terminal of the second reset TFT switch 6 is connected to a gate of an OLED driving TFT 3. Other structures are the same as those of FIG. 4.

In the operation of FIG. 9, when the second reset TFT switch 6 is turned on in the period A of FIG. 5, the reference potential of the OLED element 1 is applied to the gate of an OLED driving TFT 3. In this state, red pixel data, green pixel data, and blue pixel data are written in a capacitive element 4 in this order. The subsequent operation of the period B is the same as described in the first embodiment of the present invention.

The above-mentioned description has been made on the assumption that the OLED driving TFT 3 is the p-type TFT. However, even in the case of an n-type OLED driving TFT 3, the present invention can be applied thereto. In FIG. 9 in which the p-type OLED driving TFT 3 is used, the OLED driving TFT 3 is connected to a power supply side, the OLED element 1 is connected to a reference potential side, and the lighting TFT switch 2 is connected between the OLED driving TFT 3 and the OLED element 1. However, in the case where the OLED driving TFT 3 is the n-type TFT, it is preferable to connect the OLED element 1 to the power supply side, the OLED driving TFT 3 to the reference potential side, and the lighting TFT switch 2 between the OLED element 1 and the OLED driving TFT 3. In this case as well, as the matter of course, the first reset TFT switch 5 is connected between the gate and a drain of the OLED driving TFT 3.

### Third Embodiment

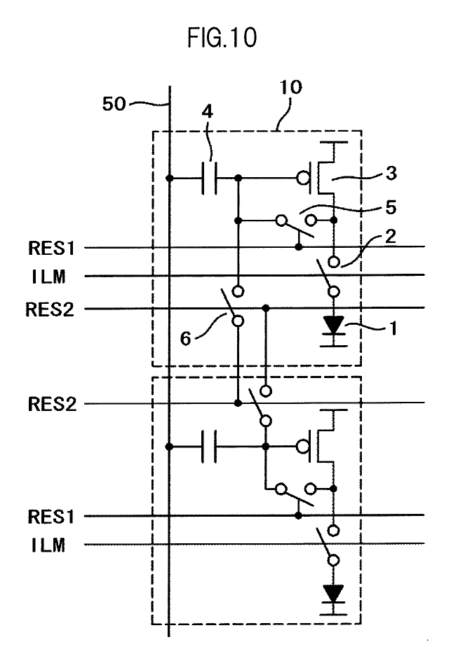

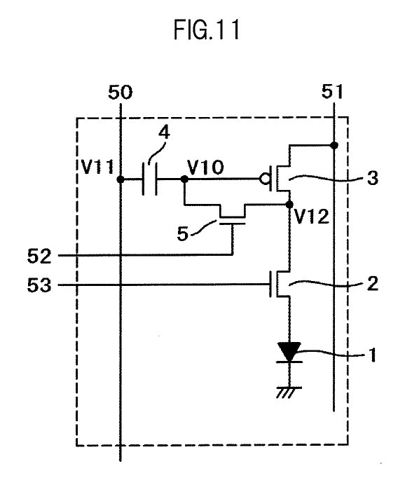

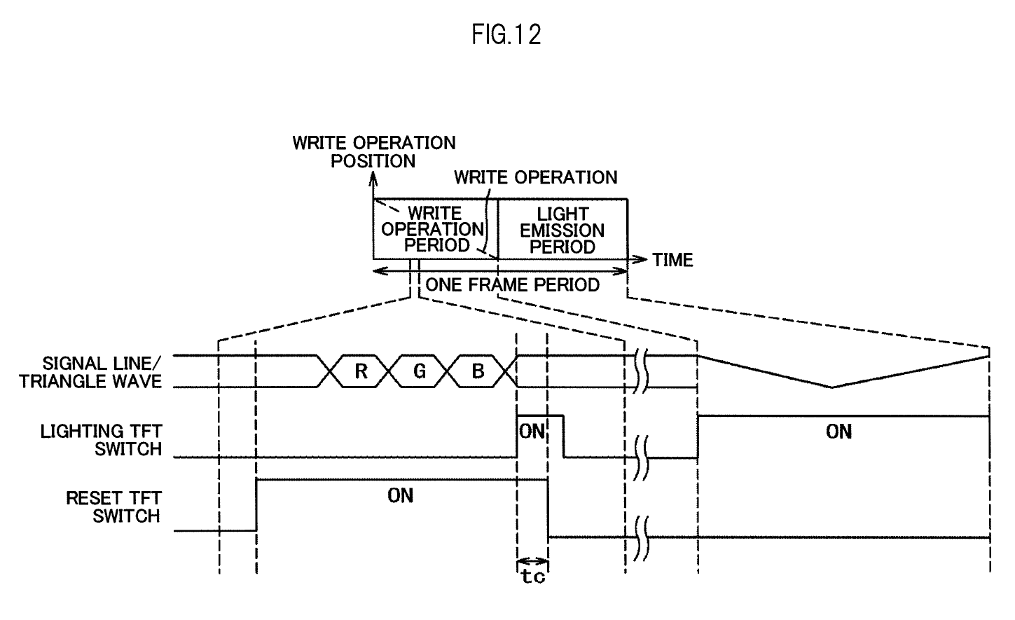

FIG. 10 is a circuit diagram illustrating a pixel circuit according to a third embodiment of the present invention. In FIG. 10, two pixels 10 are vertically arranged. In each of the pixels 10, the arrangement of an OLED driving TFT 3, a first reset TFT switch 5, a second reset TFT switch 6, a lighting TFT switch 2, an OLED element 1, and a capacitive element 4, and their functions are the same as described in the first embodiment of the present invention. Further, in the circuit of FIG. 10, only a switch symbol is described as a switch element, but those switch elements are formed of TFTs, which is the same as in the first embodiment of the present invention.

The feature of the circuit illustrated in FIG. 10 is that the second reset TFT switch 6 is connected to a second reset control line RES2 of the upper pixel or the lower pixel. This embodiment is greatly different from the first embodiment and the second embodiment of the present invention in that the second reset TFT switch 6 is not connected to a line for supplying a specific reference potential.

A drain of the second reset TFT switch 6 is connected to a gate of the OLED driving TFT 3, and a gate of the second reset TFT switch 6 is connected to the second reset control line RES2. In the first embodiment and the second embodiment of the present invention, the source of the second reset TFT switch 6 is connected to the reference potential, whereas, in this embodiment, a source thereof is connected to the second reset control line RES2 of the upper pixel or the lower pixel.

In FIG. 10, it is assumed that video data is written in the upper pixel 10. In the period A of FIG. 5, it is required to turn on the second reset TFT switch 6 and supply a predetermined potential to the gate of the OLED driving TFT 3. In this embodiment, the source of the second reset TFT switch 6 is connected to the second reset control line RES2 of the lower pixel 10.

Incidentally, when the second reset TFT switch 6 of the upper pixel 10 of FIG. 10 is ON state, it is indicated that the second reset control line RES2 is in high state. Further, during this state, the second reset control line RES2 of the lower pixel 10 is in low state. Accordingly, in the upper pixel 10, during the period A of FIG. 5, a low potential of the second reset control line RES2 of the lower pixel 10 is supplied. In this embodiment, the low potential of the second reset control line RES2 is used in place of the reference potential.

On the other hand, when video data is written in the lower pixel 10, a low potential of the second reset control line RES2 of the upper pixel 10 is used in place of the reference potential. When video data is being written in the lower pixel 10, a low potential is being supplied to the second reset control line RES2 of the upper pixel 10, which is the same condition as that of the case where the video data is being written in the upper pixel 10.

As described above, according to this embodiment, it is neither required to separately form a power supply for the reset reference potential nor to form wiring for the reset reference potential. Therefore, this embodiment is particularly effective in the case where the size of each pixel 10 is small when a high precision display is employed. Note that the structures and arrangements of the other elements of FIG. 10 are the same as those of the first embodiment of the present invention. Further, the reset operation is also the same as described in the first embodiment of the present invention.

The above-mentioned description has been made on the assumption that the OLED driving TFT 3 is the p-type TFT. However, even in the case of an n-type OLED driving TFT 3, the present invention can be similarly applied thereto. In FIG. 10 in which the p-type OLED driving TFT 3 is used, the OLED driving TFT 3 is connected to a power supply side, the OLED element 1 is connected to a reference potential side, and the lighting TFT switch 2 is connected between the OLED driving TFT 3 and the OLED element 1. However, in the case where the OLED driving TFT 3 is the n-type TFT, it is preferable to connect the OLED element 1 to the power supply side, the OLED driving TFT 3 to the reference potential side, and the lighting TFT switch 2 between the OLED element 1 and the OLED driving TFT 3. In this case as well, as the matter of course, the first reset TFT switch 5 is connected between the gate and a drain of the OLED driving TFT 3.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An organic electroluminescence display device, comprising:
a display portion formed of a plurality of pixels each including a self-light-emitting element;
a data line for inputting an image data signal into the display portion; and
a field effect transistor for driving the self-light-emitting element based on image data input into each of the plurality of pixels via the data line, wherein:
the field effect transistor is connected to a first switch and an organic light emitting diode element in series between a power supply and a first reference potential, and has a drain and a gate connected to a second switch provided therebetween;
the gate of the field effect transistor is connected to a second reference potential with a third switch being connected therebetween; and
the gate of the field effect transistor is connected to one terminal of a capacitive element, and the data line is connected to another terminal of the capacitive element.

2. An organic electroluminescence display device according to claim 1, wherein each of the field effect transistor, the first switch, the second switch, and the third switch is formed of a thin film transistor.

3. An organic electroluminescence display device according to claim 1, wherein:
the field effect transistor is p-type and is connected to the power supply; and
the organic light emitting diode element is connected to the first reference potential.

4. An organic electroluminescence display device according to claim 1, wherein:
the field effect transistor is n-type and is connected to the first reference potential; and
the organic light emitting diode element is connected to the power supply.

5. An organic electroluminescence display device according to claim 1, wherein the first reference potential and the second reference potential are equal to each other.

6. An organic electroluminescence display device, comprising:
a display portion formed of a plurality of pixels including a first pixel and a second pixel each including a self-light-emitting element;
a data line for inputting an image data signal into the display portion; and
a field effect transistor for driving the self-light-emitting element based on image data input into each of the plurality of pixels via the data line, wherein:
the first pixel is configured so that:
the field effect transistor is connected to a first switch and an organic light emitting diode element in series between a power supply and a first reference potential;
the field effect transistor has a drain and a gate connected to a second switch provided therebetween;
the gate of the field effect transistor is connected to a third switch which is controlled by a control line; and
the gate of the field effect transistor is connected to one terminal of a capacitive element, and the data line is connected to another terminal of the capacitive element;
the second pixel has the same structure as in the first pixel; and
the third switch of the first pixel is connected to a control line of the second pixel, and a third switch of the second pixel is connected to the control line of the first pixel.

7. An organic electroluminescence display device according to claim 6, wherein each of the field effect transistor, the first switch, the second switch, and the third switch is formed of a thin film transistor.

8. An organic electroluminescence display device according to claim 6, wherein:
the field effect transistor is p-type and is connected to the power supply; and
the organic light emitting diode element is connected to the first reference potential.

9. An organic electroluminescence display device according to claim 6, wherein:
the field effect transistor is n-type and is connected to the first reference potential; and
the organic light emitting diode element is connected to the power supply.

10. A driving method for an organic electroluminescence display device comprising:
a display portion formed of a plurality of pixels each including a self-light-emitting element;
a data line for inputting an image data signal into the display portion; and
a field effect transistor for driving the self-light-emitting element based on image data input into each of the plurality of pixels via the data line,
the field effect transistor being connected to a first switch and an organic light emitting diode element in series between a power supply and a first reference potential,
the field effect transistor having a drain and a gate connected to a second switch provided therebetween,
the gate of the field effect transistor being connected to a second reference potential with a third switch being connected therebetween,
the gate of the field effect transistor being connected to one terminal of a capacitive element and the data line being connected to another terminal of the capacitive element, wherein:
one frame period is divided into a data write period in which data is written in the plurality of pixels and a light emission period of the plurality of pixels; and
in the data write period, the third switch is closed when data is being input from the data line into the capacitive element, the second reference potential is applied to the gate of the field effect transistor, and the third switch is open when the second switch is closed.

11. A driving method for an organic electroluminescence display device according to claim 10, wherein, in the data write period, the first switch is open and the organic light emitting diode element does not emit light.

12. A driving method for an organic electroluminescence display device according to claim 10, wherein the first reference potential and the second reference potential are equal to each other.

13. A driving method for an organic electroluminescence display device comprising:
a display portion formed of a plurality of pixels including a first pixel and a second pixel each including a self-light-emitting element;
a data line for inputting an image data signal into the display portion; and
a field effect transistor for driving the self-light-emitting element based on image data input into each of the plurality of pixels via the data line,
the first pixel being configured so that:
the field effect transistor is connected to a first switch and an organic light emitting diode element in series between a power supply and a first reference potential;
the field effect transistor has a drain and a gate connected to a second switch provided therebetween;
the gate of the field effect transistor is connected to a third switch which is controlled by a control line; and
the gate of the field effect transistor is connected to one terminal of a capacitive element, and the data line is connected to another terminal of the capacitive element;
the second pixel having the same structure as in the first pixel,
the third switch of the first pixel being connected to a control line of the second pixel and a third switch of the second pixel being connected to the control line of the first pixel, wherein:
one frame period is divided into a data write period in which data is written in the plurality of pixels and a light emission period of the plurality of pixels;
in the data write period, the first pixel is configured so that the third switch is closed when data is being input from the data line into the capacitive element, an OFF potential of the control line of the second pixel is supplied to the gate of the field effect transistor, and the third switch is open when the second switch is closed; and
the second pixel is configured so that the third switch is closed when data is being input from the data line into the capacitive element, an OFF potential of the control line of the first pixel is supplied to the gate of the field effect transistor, and the third switch is open when the second switch is closed.

14. A driving method for an organic electroluminescence display device according to claim 13, wherein, in the data write period, the first switch of the first pixel and a first switch of the second pixel are open, and the organic light emitting diode element of the first pixel and an organic light emitting diode element of the second pixel do not emit light.
